(19) United States
(12) Patent Application Publication
(10) Pub. No.: US 2022/0324749 A1
(43) Pub. Date: Oct. 13, 2022

(54) CRYSTALLIZED GLASS AND REINFORCED CRYSTALLIZED GLASS

(71) Applicant: OHARA INC., KANAGAWA (JP)

(72) Inventors: KEISUKE SHIMAMURA, KANAGAWA (JP); TOSHITAKA YAGI, KANAGAWA (JP); KOHEI OGASAWARA, KANAGAWA (JP)

(21) Appl. No.: 17/640,341

(22) PCT Filed: Aug. 19, 2020
(86) PCT No.: PCT/JP2020/031201

§ 371 Date: Mar. 4, 2022

(30) Foreign Application Priority Data
Sep. 5, 2019 (JP) 2019-161899
Oct. 15, 2019 (JP) 2019-188957

(51) Int. Cl. C03C 10/00; C03C 4/18; C03C 21/00

(52) U.S. Cl. CPC C03C 10/0018; C03C 10/0045; C03C 4/18; C03C 21/002; C03C 2204/00

(57) ABSTRACT

Crystallized glass and strengthened crystallized glass with a novel composition, which have a high refractive index and high hardness, are provided. A crystallized glass, including, by mass % in terms of oxide, 20.0% or more and less than 40.0% of a SiO₂ component, more than 0% and 20.0% or less of a Rn₂O component, where Rn is one or more selected from Li, Na, and K, 7.0% to 25.0% of an Al₂O₃ component, 0% to 25.0% of a MgO component, 0% to 45.0% of a ZnO component, and 0% to 20.0% of a Ta₂O₅ component, in which a total amount of the MgO component, the ZnO component, and the Ta₂O₅ component is 10.0% or more.

### FIELD OF THE DISCLOSURE

The present disclosure relates to crystallized glass and strengthened crystallized glass having a compressive stress layer.

### BACKGROUND OF THE DISCLOSURE

A cover glass for protecting a display is used in a portable electronic device such as a smartphone or a tablet PC. A protector for protecting a lens is also used in an in-vehicle optical device. In recent years, there is a demand for a use in a housing or the like serving as an exterior of an electronic device. There is an increasing demand for a hard material so that these devices can withstand a rigorous use.

There is crystallized glass obtained by increasing the strength of glass. The crystallized glass is obtained by precipitating crystals inside of the glass, and is known to have a superior mechanical strength to amorphous glass.

Chemical strengthening is known as a method for further strengthening glass. When an alkaline component existing in a surface layer of glass is subject to exchange reaction with an alkaline component with a larger ionic radius to form a compressive stress layer on the surface layer, it is possible to suppress the growth of cracks and increase the mechanical strength.

Patent Document 1 and 2 disclose high-strength crystallized glass and a chemically strengthened version of the high-strength crystallized glass. However, there is a demand for crystallized glass having a high refractive index in addition to high hardness, which enables wider use as an optical material.

### PRIOR ART DOCUMENT

### Patent Document

[Patent Document 1] Japanese Unexamined Patent Application Publication No. 2011-207626

[Patent Document 2] Japanese Unexamined Patent Application Publication No. 2017-001937

### SUMMARY OF THE DISCLOSURE

An object of the present disclosure is to provide crystallized glass and strengthened crystallized glass with a novel composition, which have a high refractive index and high hardness.

The present disclosure provides the following.

### (Configuration 1)

A crystallized glass, including, by mass % in terms of oxide,

20.0% or more and less than 40.0% of a SiO₂ component,

more than 0% and 20.0% or less of a Rn₂O component, where Rn is one or more selected from Li, Na, and K,

7.0% to 25.0% of an Al₂O₃ component,

0% to 25.0% of a MgO component,

0% to 45.0% of a ZnO component, and

0% to 20.0% of a Ta₂O₅ component,

wherein a total amount of the MgO component, the ZnO component, and the Ta₂O₅ component is 10.0% or more.

### (Configuration 2)

The crystallized glass according to Configuration 1, including, by mass % in terms of oxide,

0% to 15.0% of a TiO₂ component,

0% to 15.0% of a CaO component,

0% to 15.0% of a BaO component, and

0% to 10.0% of a SrO component.

### (Configuration 3)

The crystallized glass according to Configuration 1 or 2, including, by mass % in terms of oxide,

0% to 10.0% of a ZrO₂ component,

0% to 10.0% of a WO₃ component,

0% to 10.0% of a La₂O₃ component,

0% to 15.0% of a Gd₂O₃ component,

0% to 15.0% of a Bi₂O₃ component,

0% to 10.0% of a P₂O₅ component,

0% to 10.0% of a Nb₂O₅ component, and

0to 5.0% of a Sb₂O₃ component.

### (Configuration 4)

The crystallized glass according to any one of Configurations 1 to 3, wherein the total amount of the MgO component, the ZnO component, and the Ta₂O₅ component is 18.0% or more.

### (Configuration 5)

The crystallized glass according to any one of Configurations 1 to 4, wherein the crystallized glass has a refractive index (n_{d}) of 1.55 or more.

### (Configuration 6)

The crystallized glass according to any one of Configurations 1 to 5, wherein the crystallized glass has a specific gravity of 3.0 or more.

### (Configuration 7)

A strengthened crystallized glass including, as a base material, the crystallized glass according to any one of Configurations 1 to 6, and further including a compressive stress layer formed in a surface of the strengthened crystallized glass.

According to the present disclosure, it is possible to provide crystallized glass and strengthened crystallized glass with a novel composition, which has a high refractive index and high hardness.

The crystallized glass or strengthened crystallized glass of the present disclosure can be used as a cover glass or housing of a smartphone, a tablet, a PC, or an optical member of a filter, a camera or the like (a lens, a substrate, etc.). Specifically, the crystallized glass or strengthened crystallized glass of the present disclosure can be used for an in-vehicle lens, a lens for short-focus projector, a wearable device, ornament (for a vehicle, a building, a smart key, etc.), a touch panel, and a dielectric filter, for example. A high refractive index facilitates use of more compact design, and high strength facilitates production of thinner and lighter products.

### DETAILED DESCRIPTION OF THE EXEMPLARY EMBODIMENTS

Embodiments and examples of according to the present disclosure will be described below in detail, but the present disclosure is not limited to the following embodiments and examples, and may be implemented with appropriate changes within the scope of the object of the present disclosure.

As used herein, all the contents of each component are expressed by mass % in terms of oxide unless otherwise specified. Here, “in terms of oxide” means, if it is assumed that all the components included in the crystallized glass are dissolved and converted into oxides and a total mass of the oxides is 100 mass %, an amount of oxides in each of the components contained in the crystallized glass is expressed by mass %. As used herein, “A to B %” represents A % or more and B % or less. Further, “0%” of “0% to C %” means a content of 0%.

A crystallized glass of the present disclosure includes

20.0% or more and less than 40.0% of a SiO₂ component,

more than 0% and 20.0% or less of a Rn₂O component, where Rn is one or more selected from Li, Na, and K,

7.0% to 25.0% of an Al₂O₃ component,

0% to 25.0% of a MgO component,

0% to 45.0% of a ZnO component, and

0% to 20.0% of a Ta₂O₅ component,

and a total amount of the MgO component, the ZnO component, and the Ta₂O₅ component is 10.0% or more.

Generally, when content of the SiO₂ component which is a glass-forming component is low and content of a crystal forming component (e.g., ZnO) is high, formation of glass tends to be difficult. However, according to the present disclosure, crystallized glass can be obtained with the above-described composition.

Further, the crystallized glass of the present disclosure contains a predetermined amount of a component increasing the refractive index, such as a ZnO component, an MgO component, and a Ta₂O₅ component, and thus exhibits a high refractive index.

That is, use of the above-described composition makes it possible to produce a hard crystallized glass having a high refractive index.

Furthermore, use of chemical strengthening further increases the hardness of the crystallized glass.

Crystallized glass is also called glass-ceramics, and is a material obtained by subjecting glass to heat treatment to precipitate crystals inside the glass. The crystallized glass is a material having a crystalline phase and a glass phase, and is distinguished from an amorphous solid. Generally, the crystalline phase of the crystallized glass is determined by using a peak angle appearing in an X-ray diffraction pattern of X-ray diffraction analysis.

The crystallized glass of the present disclosure contains, for example, one or more selected from ZnAl₂O₄, Zn₂Ti₃O₈, Zn₂SiO₄, ZnTiO₃, Mg₂SiO₄, Mg₂Al₄Si₅O₁₈, NaAlSiO₄, Na₂Zn₃SiO₄, Na₄Al₂Si₂O₉, LaTiO₃, and solid solutions thereof, as a main crystal phase.

The “main crystal phase” as used herein corresponds to a crystalline phase contained in the largest amount in the crystallized glass, which is determined from the peak of the X-ray analysis diagram.

The SiO₂ component is a glass-forming component forming the network structure of glass, and is an essential component. On the other hand, if the SiO₂ component is insufficient, the obtained glass has poor chemical durability and decreased devitrification resistance.

Therefore, the upper limit of the content of the SiO₂ component may be less than 40.0%, 39.0% or less, 37.0% or less, or 35.0% or less. Further, the lower limit of the content of the SiO₂ component may be 20.0% or more, 23.0% or more, 25.0% or more, or 30.0% or more.

The Rn₂O component (where Rn is one or more selected from Li, Na, and K) is a component involved in ion exchange during chemical strengthening, but if contained excessively, causes poor chemical durability and decreased devitrification resistance in the obtained glass.

Therefore, the upper limit of the content of the Rn₂O component may be 20.0% or less, 18.0% or less, 15.0% or less, or 14.0% or less. Further, the lower limit of the content of the Rn₂O component may be more than 0%, 2.0% or more, 4.0% or more, or 6.0% or more.

In particular, the Na₂O component is preferably used as an essential component due to the fact that, for example, as a result of progress of an exchange reaction of a potassium component (K⁺ ion) having a large ionic radius in a molten salt and a sodium component (Na⁺ ion) having a small ionic radius in a substrate, a compressive stress is formed in a substrate surface.

Therefore, the upper limit of the content of the Na₂O component may be 20.0% or less, 18.0% or less, 15.0% or less, or 14.0% or less. The lower limit of the content of the Na₂O component may be more than 0%, 2.0% or more, 4.0% or more, or 6.0% or more.

The Al₂O₃ component is a component suitable for improving a mechanical strength, but if contained excessively, causes poor meltability and devitrification resistance in the obtained glass.

Therefore, the upper limit of the content of the Al₂O₃ component may be 25.0% or less, 23.0% or less, 22.0% or less, or 20.0% or less. Further, the lower limit of the content of the Al₂O₃ component may be 7.0% or more, 9.0% or more, 10.0% or more, or 11.0% or more.

The MgO component is a component increasing the refractive index and contributes to increased mechanical strength, but if contained excessively, causes poor devitrification resistance in the obtained glass.

Therefore, the upper limit of the content of the MgO component may be 25.0% or less, 22.0% or less, 20.0% or less, 18.0% or less, or 15.0% or less. Further, the lower limit of the content of the MgO component may be 0% or more, 1.0% or more, 1.5% or more, or 2.0% or more.

The ZnO component is a component not only increasing the refractive index and contributing to increased mechanical strength but also effective in reducing the viscosity of the glass, but if contained excessively, causes poor devitrification resistance in the obtained glass.

Therefore, the upper limit of the content of the ZnO component may be 45.0% or less, 40.0% or less, 38.0% or less, or 25.0% or less. Further, the lower limit of the content of the ZnO component may be 0% or more, 2.0% or more, 5.0% or more, or 8.0% or more, 10.0% or more.

The Ta₂O₅ component is a component increasing the refractive index, but if contained excessively, causes poor devitrification resistance in the obtained glass.

Therefore, the upper limit of the content of the Ta₂O₅ component may be 20.0% or less, 19.0% or less, 17.0% or less, or 15.0% or less.

Further, the lower limit of the content of the Ta₂O₅ component may be 0% or more, 1.0% or more, 3.0% or more, or 5.0% or more. Moreover, the lower limit of the content of the Ta₂O₅ component may be more than 5.0 mol %, or 5.5 mol % or more.

The total amount of the MgO component, the ZnO component, and the Ta₂O₅ component may be adjusted to obtain a high refractive index, but if contained excessively, causes poor devitrification resistance in the obtained glass.

Therefore, the lower limit of the total amount of the MgO component, the ZnO component, and the Ta₂O₅ component may preferably be 10.0% or more, 15.0% or more, 18.0% or more, or 20.0% or more. Preferably, the upper limit of the total amount of the MgO component, the ZnO component, and the Ta₂O₅ component may preferably be 45.0% or less, 40.0% or less, or 38.0% or less.

The total amount of the ZnO component and the Ta₂O₅ component may be adjusted to obtain a high refractive index. On the other hand, if the ZnO component and the Ta₂O₅ component are contained excessively, the obtained glass has poor devitrification resistance.

Therefore, the lower limit of the total amount of the ZnO component and the Ta₂O₅ component may preferably be 5.0% or more, 8.0% or more, or 10.0% or more, and the upper limit of the total amount of the ZnO component and the Ta₂O₅ component may preferably be 35.0% or less, 30.0% or less, or 28.0% or less.

A TiO₂ component is a component contributing to a crystallization nucleating agent and a high refractive index.

Therefore, the content of the TiO₂ component may be preferably 0% to 15.0%, more preferably 1.0% to 13.0%, still more preferably 2.0% to 10.0%.

A CaO component, a BaO component, and a SrO component are components contributing to the improvement of the refractive index and the stabilization of the glass.

Therefore, the content of the CaO component may be preferably 0% to 15.0%, more preferably 0.1% to 13.0%, still more preferably 0.5% to 10.0%.

The content of the BaO component may be preferably 0% to 15.0%, more preferably 0% to 13.0%, still more preferably 0% to 12.0%.

The content of the SrO component may be preferably 0% to 10.0%, more preferably 0% to 8.0%, still more preferably 0% to 7.0%.

A ZrO₂ component, a WO₃ component, a La₂O₃ component, a P₂O₅ component, and a Nb₂O₅ component may or may not each be contained in the crystallized glass. The content of each component may be 0 to 10.0%, 0 to 8.0%, or 0 to 7.0%.

A Gd₂O₃ component and a Bi₂O₃ component may or may not each be contained in the crystallized glass. The content of each component may be 0 to 15.0%, 0 to 13.0%, or 0 to 10.0%.

A B₂O₃ component, a Y₂O₃ component, and a TeO₂ component may or may not each be contained in the crystallized glass. The content of each component may be 0 to 2.0%, 0% or more and less than 2.0%, or 0 to 1.0%.

The crystallized glass may contain, as a clarifying agent, 0% to 5.0%, preferably 0.03% to 2.0%, more preferably 0.05% to 1.0% of one or more selected from a Sb₂O₃ component, a SnO₂ component, and a CeO₂ component.

The above blending amounts may be combined as appropriate.

The total content of the SiO₂ component, the Rn₂O component, the Al₂O₃ component, the MgO component, the ZnO component, and the Ta₂O₅ component may be adjusted to produce glass that contains one or more types selected from RAl₂O₄ and R₂SiO₄, (where R is one or more types selected from Zn and Mg), as a crystalline phase, and that can be chemically strengthened by an ion exchange. At the same time, it is possible to obtain a glass having excellent mechanical strength and a high refractive index.

Therefore, the lower limit of the mass sum of SiO₂+Rn₂O+Al₂O₃+MgO +ZnO+Ta₂O₅ may be 70.0% or more, 75.0% or more, 80.0% or more, or 85.0% or more.

The crystallized glass of the present disclosure has a high refractive index (n_{d}). Preferably, the lower limit of the refractive index is 1.55 or more, 1.58 or more, 1.60 or more, or 1.61 or more. Generally, the upper limit of the refractive index is 1.65 or less.

The crystallized glass of the present disclosure has a high Vickers hardness. Generally, the lower limit of Vickers hardness is 500 or more, preferably 600 or more, and more preferably 700 or more. Generally, the upper limit of Vickers hardness is 800 or less. The crystallized glass strengthened by chemical strengthening or the like has a higher hardness of 800 to 900, for example.

The crystallized glass of the present disclosure generally has a heavy specific gravity, and the lower limit of the specific gravity is 2.95 or more, or 3.00 or more. Generally, the upper limit of the specific gravity is 3.40 or less.

The crystallized glass of the present disclosure may be produced by the following method. That is, raw materials are uniformly mixed and the mixed raw materials are melted and molded to produce a raw glass. Next, the raw glass is crystallized to produce the crystallized glass. The crystallized glass may be used as a base material and a compressive stress layer may be formed in the base material to further strengthen the glass.

The raw glass is subject to heat treatment to precipitate crystals in the glass. The heat treatment may be performed at a one-stage temperature or a two-stage temperature.

In the two-stage heat treatment, in a nucleation step, the raw glass is firstly applied to heat treatment at a first temperature, and after the nucleation step, in a crystal growth step, the raw glass is applied to heat treatment at a second temperature higher than that in the nucleation step.

In the one-stage heat treatment, the nucleation step and the crystal growth step are continuously performed at the one-stage temperature. Typically, the temperature is raised to a predetermined heat treatment temperature, is maintained for a certain period of time after reaching the predetermined heat treatment temperature, and is then lowered.

The first temperature of the two-stage heat treatment is preferably 600° C. to 750° C. A retention time at the first temperature is preferably 30 minutes to 2000 minutes, and more preferably 180 minutes to 1440 minutes.

The second temperature of the two-stage heat treatment is preferably 650° C. to 850° C. A retention time at the second temperature is preferably 30 minutes to 600 minutes, and more preferably 60 minutes to 300 minutes.

When the heat treatment is performed at the one-stage temperature, the heat treatment temperature is preferably 600° C. to 800° C., and more preferably 630° C. to 770° C. A retention time at the heat treatment temperature is preferably 30 minutes to 500 minutes, and more preferably 60 minutes to 300 minutes.

When the substrate is chemically strengthened, normally, a thin plate-shaped crystallized glass is produced from the crystallized glass, by using for example, means of grinding and polishing and the like. Thereafter, a compressive stress layer is formed in the crystallized glass substrate through ion exchange by a chemical strengthening method.

An example of a method for forming the compressive stress layer includes a chemical strengthening method in which an alkaline component present in a surface layer of the crystallized glass is subject to exchange reaction with an alkaline component with a larger ionic radius to form a compressive stress layer on the surface layer. Other examples include a heat strengthening method in which the crystallized glass is heated and is subsequently quenched and an ion implantation method in which ions are implanted into the surface layer of the crystallized glass.

The chemical strengthening method may be implemented according to the following steps, for example. A crystallized glass base material is contacted to or immersed in a molten salt of a salt containing potassium or sodium, for example, potassium nitrate (KNO₃), sodium nitrate (NaNO₃) or a mixed salt or a complex salt thereof. The treatment of contacting or immersing the crystallized glass base material to and in the molten salt (chemical strengthening treatment) may be performed in one stage or in two stages.

For example, in the case of the two-stage chemical strengthening treatment, firstly, the crystallized glass base material is contacted to or immersed in a sodium salt or a mixed salt of potassium and sodium heated at 350° C. to 550° C. for 1 to 1440 minutes, preferably 90 to 800 minutes. Subsequently, secondly, the resultant crystallized glass base material is contacted to or immersed in a potassium salt or a mixed salt of potassium and sodium heated at 350° C. to 550° C. for 1 to 1440 minutes, preferably 60 to 800 minutes.

In the case of the one-stage chemical strengthening treatment, the crystallized glass base material is contacted to or immersed in a salt containing potassium or sodium, or a mixed salt thereof heated at 350° C. to 550° C. for 1 to 1440 minutes, preferably 60 to 800 minutes.

The heat strengthening method is not particularly limited, but, for example, the crystallized glass base material may be heated to 300° C. to 600° C., and thereafter, be applied to rapid cooling such as water cooling and/or air cooling to form the compressive stress layer by a temperature difference between the surface and the inside of the glass substrate. It is noted that when the heat strengthening method is combined with the above chemical treatment method, it is possible to effectively form the compressive stress layer.

The ion implantation method is not particularly limited, but, for example, an arbitrary ion may be collided on the surface of the crystallized glass base material with an acceleration energy and an acceleration voltage that would not destroy the surface of the base material to implant the ions into the surface of the base material. Thereafter, when heat treatment is applied to the resultant surface of the base material as necessary, it is possible to form the compressive stress layer on the surface in much the same manner as in the other methods.

### EXAMPLES

### Examples 1 to 35

### 1. Manufacture of Crystallized Glass

Raw materials such as oxides, hydroxides, carbonates, nitrates, fluorides, chlorides, and metaphosphate compounds corresponding to a raw material of each component of the crystallized glass were selected, and the selected raw materials were weighed and mixed uniformly to have the compositions (mass %) described in Tables 1 to 4.

Next, the mixed raw materials were injected into a platinum crucible and melted in an electric furnace at 1300° C. to 1600° C. for 2 to 24 hours depending on the difficulty of melting the glass composition. Subsequently, the molten glass was homogenized by stirring, and cooled to 1000° C. to 1450° C. Then, the molten glass was cast into the mold and cooled slowly to prepare raw glass. The obtained raw glass was heated at 730° C. for crystallization.

The produced crystallized glass was cut and ground, and the opposing sides of the resultant crystallized glass was further polished in parallel to achieve a thickness of 1 mm to obtain a crystallized glass substrate. Next, the crystallized glass substrate was used as a base material and immersed into molten salt of KNO₃ at 420° C. for 500 minutes to obtain strengthened crystallized glass.

### 2. Evaluation of Crystallized Glass

The following physical properties of the obtained crystallized glass and strengthened crystallized glass were measured. The results are shown in Tables 1 to 4.

### (1) Refractive index (n_{d})

The refractive index (n_{d}) is indicated by a measurement value for a helium lamp d line (587.56 nm) according to the V block method specified in JIS B 7071-2: 2018.

### (2) Specific gravity (d)

The specific gravity was measured according to the Archimedes method.

### (3) Vickers hardness (Hv)

The Vickers hardness was evaluated by pushing a 136° pyramidal diamond indenter with a load of 980.7 mN for 10 seconds and by dividing the load by the surface area (mm²) calculated from the length of the indentation. The measurement was performed using a micro Vickers hardness tester HMV-G manufactured by Shimadzu Corporation.

### (4) Stress measurement

For the strengthened crystallized glass of Examples 3, 5, 6, 13, and 20, a compressive stress value (CS) of the surface and a thickness of the compressive stress layer (stress depth DOLzero) were measured by using a glass surface stress meter FSM-6000LE series manufactured by Orihara Manufacturing Co., LTD. As a light source of a meter used in the CS measurement, a light source having a wavelength of 596 nm was selected for the measurement. As the refractive index used for the CS measurement, the value of the refractive index of 596 nm was used. It is noted that the value of the refractive index at a wavelength of 596 nm was calculated by using a quadratic approximation expression from the measured values of the refractive index at the wavelengths of a C-line, a d-line, an F-line, and a g-line according to the V-block method specified in JIS B 7071-2: 2018. The central compressive stress value (CT) was evaluated by using Curve analysis.
(4) Photoelastic constant (β)

The values shown in Tables 1 to 4 were employed for the values of photoelastic constants β (nm/cm/10⁵ Pa), which are the CS measurement conditions. As the photoelastic constants used for the CS measurement, the value of the photoelastic constant at 596 nm was used.

In a method of measuring the photoelastic constant, the opposing sides of a sample shape were polished to form a disk with a diameter of 25 mm and a thickness of 8 mm, a compressive load 0 to about 100 kgf was applied to the disk in a side surface direction, an optical path difference occurring in the center of the glass was measured, and the photoelastic constant was calculated by the relational expression of δ=β*d*F. In the above expression, δ (nm) denotes the optical path difference, d (cm) denotes the glass thickness, and F (MPa) denotes the stress.

The crystallized glass of Examples 11, 14, 23, 24, and 26 to 30 was devitrified due to the high crystallization temperature, and thus, the refractive index for these Examples could not be measured. As shown in Tables 1 to 4, the Vickers hardness is increased by the chemical strengthening, and this indicates formation of the compressive stress layer. The crystallized glass of Example 29 shattered in a salt bath and could not be chemically strengthened.

### Example 36

Crystallized glass was produced in much the same way as in Example 24 except that the crystallization temperature was set to 680° C. Devitrification did not occur and thus the refractive index could be measured. The refractive index was 1.63, the specific gravity was 3.16, and the Vickers hardness was 755.

### Example 37

Crystallized glass was produced in much the same way as in Example 26 except that the crystallization temperature was set to 700° C. Devitrification did not occur and thus the refractive index could be measured. The refractive index was 1.63 and the specific gravity was 3.18.

### Example 38

Crystallized glass and strengthened crystallized glass were produced in much the same way as in Example 2 except that the crystallization temperature was set to 760° C. The refractive index of the crystallized glass was 1.60, the specific gravity was 3.05, the Vickers hardness was 682, and the Vickers hardness of the strengthened crystallized glass was 803.

### Example 39

Crystallized glass and strengthened crystallized glass were produced in much the same way as in Examples 7 and 8 except that the crystallization temperature was set to 760° C. The specific gravities of the crystallized glass were 3.17 and 3.15, respectively, and the Vickers hardnesses of the strengthened crystallized glass were 815 and 834, respectively.

### Comparative Example 1

Crystallized glass of Example 26 of Patent Document 2 was used as Comparative Example 1. The crystallized glass of Comparative Example 1 was evaluated in much the same way as in Examples. The results are shown in Table 4.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| Composition | SiO₂ | 39.42 | 39.37 | 39.37 | 39.12 | 37.12 | 34.37 | 34.37 | 35.37 | 36.37 | 38.37 |
| (mass %) | Li₂O | | | | | | | | | | |
| | Na₂O | 10.20 | 10.19 | 10.19 | 9.50 | 9.50 | 10.19 | 10.19 | 10.19 | 10.19 | 8.19 |
| | K₂O | | | | | | | | | | |
| | Al₂O₃ | 14.80 | 14.81 | 14.81 | 15.70 | 17.70 | 14.81 | 14.81 | 14.81 | 14.81 | 14.81 |
| | P₂O₅ | | | | | | | | | | |
| | MgO | 5.80 | 5.79 | 5.79 | 5.40 | 5.40 | 5.79 | 5.79 | 9.79 | 5.79 | 5.79 |
| | CaO | 0.90 | 0.93 | 0.93 | 1.00 | 1.00 | 0.93 | 0.93 | 0.93 | 0.93 | 0.93 |
| | SrO | | | 5.00 | | | | | | | |
| | BaO | | 5.00 | | | | 10.00 | 5.00 | 5.00 | 5.00 | 5.00 |
| | ZnO | 11.80 | 11.81 | 11.81 | 11.00 | 11.00 | 11.81 | 11.81 | 11.81 | 14.81 | 11.81 |
| | ZrO₂ | 5.00 | | | | | | | | | |
| | TiO₂ | 4.60 | 4.63 | 4.63 | 4.20 | 4.20 | 4.63 | 4.63 | 4.63 | 4.63 | 7.63 |
| | Bi₂O₃ | | | | | | | | | | |
| | Nb₂O₅ | | | | | | | 5.00 | | | |
| | Ta₂O₅ | 7.40 | 7.41 | 7.41 | 14.00 | 14.00 | 7.41 | 7.41 | 7.41 | 7.41 | 7.41 |
| | La₂O₃ | | | | | | | | | | |
| | Gd₂O₃ | | | | | | | | | | |
| | WO₃ | | | | | | | | | | |
| | SnO₂ | | | | | | | | | | |
| | Sb₂O₃ | 0.08 | 0.07 | 0.07 | 0.08 | 0.08 | 0.07 | 0.07 | 0.07 | 0.07 | 0.07 |
| | total | 100 | 100 | 100 | 100 | 100 | 100 | 100 | 100 | 100 | 100 |
| Rn₂O (mass %) | | 10.20 | 10.19 | 10.19 | 9.50 | 9.50 | 10.19 | 10.19 | 10.19 | 10.19 | 8.19 |
| MgO + ZnO + Ta₂O₅ (mass %) | | 25.00 | 25.00 | 25.00 | 30.40 | 30.40 | 25.00 | 25.00 | 29.00 | 28.00 | 25.00 |
| ZnO + Ta₂O₅ (mass %) | | 19.20 | 19.21 | 19.21 | 25.00 | 25.00 | 19.21 | 19.21 | 19.21 | 22.22 | 19.21 |
| Crystallized | n_{d} | 1.61 | 1.60 | 1.60 | 1.60 | 1.61 | 1.62 | 1.63 | 1.61 | 1.61 | 1.62 |
| glass | d | 3.04 | 3.05 | 3.03 | 3.07 | 3.10 | 3.19 | 3.17 | 3.13 | 3.14 | 3.10 |
| | Hv | 678 | 679 | 681 | 689 | 704 | 687 | 712 | 714 | 715 | 705 |
| Strengthened | CS | | | 1203 | | 1427 | 1245 | | | | |
| crystallized | DOLzero | | | 6 | | 27 | 6 | | | | |
| glass | CT | | | 8 | | 33 | 8 | | | | |
| | β | | | 29.5 | | 27.6 | 28.1 | | | | |
| | Hv | 803 | 799 | 785 | 838 | 849 | 751 | 799 | 779 | 787 | 834 |

TABLE 2

| | | Ex. 11 | Ex. 12 | Ex. 13 | Ex. 14 | Ex. 15 | Ex. 16 | Ex. 17 | Ex. 18 | Ex. 19 | Ex. 20 |
|---|---|---|---|---|---|---|---|---|---|---|---|
| Composition | SiO₂ | 33.37 | 34.37 | 34.72 | 34.72 | 36.72 | 34.72 | 34.72 | 34.72 | 34.72 | 34.72 |
| (mass %) | Li₂O | | | | | | | | | | |
| | Na₂O | 8.19 | 10.19 | 10.20 | 11.20 | 10.70 | 10.70 | 8.20 | 9.70 | 9.70 | 8.70 |
| | K₂O | | | | | | | | | | |
| | Al₂O₃ | 14.81 | 14.81 | 15.00 | 17.00 | 16.00 | 16.00 | 15.00 | 15.00 | 15.00 | 16.00 |
| | P₂O₅ | | | | | | | | | | |
| | MgO | 5.79 | 5.79 | 9.00 | 9.00 | 10.00 | 10.00 | 9.00 | 12.00 | 10.00 | 12.00 |
| | CaO | 8.93 | 0.93 | 5.00 | 1.00 | 1.00 | 1.00 | 5.00 | 1.00 | 1.00 | 1.00 |
| | SrO | | | | | | | | | | |
| | BaO | 5.00 | 5.00 | | | | | | | | |
| | ZnO | 11.81 | 11.81 | 14.00 | 14.00 | 13.00 | 13.00 | 16.00 | 13.00 | 15.00 | 13.00 |
| | ZrO₂ | | | | | | | | | | |
| | TiO₂ | 4.63 | 4.63 | 4.50 | 5.50 | 5.00 | 5.00 | 4.50 | 5.00 | 5.00 | 5.00 |
| | Bi₂O₃ | | | | | | | | | | |
| | Nb₂O₅ | | | | | | | | | | |
| | Ta₂O₅ | 7.41 | 7.41 | 7.50 | 7.50 | 7.50 | 9.50 | 7.50 | 9.50 | 9.50 | 9.50 |
| | La₂O₃ | | 5.00 | | | | | | | | |
| | Gd₂O₃ | | | | | | | | | | |
| | WO₃ | | | | | | | | | | |
| | SnO₂ | | | | | | | | | | |
| | Sb₂O₃ | 0.07 | 0.07 | 0.08 | 0.08 | 0.08 | 0.08 | 0.08 | 0.08 | 0.08 | 0.08 |
| | total | 100 | 100 | 100 | 100 | 100 | 100 | 100 | 100 | 100 | 100 |
| Rn₂O (mass %) | | 8.19 | 10.19 | 10.20 | 11.20 | 10.70 | 10.70 | 8.20 | 9.70 | 9.70 | 8.70 |
| MgO + ZnO + Ta₂O₅ (mass %) | | 25.00 | 25.00 | 30.50 | 30.50 | 30.50 | 32.50 | 32.50 | 34.50 | 34.50 | 34.50 |
| ZnO + Ta₂O₅ (mass %) | | 19.21 | 19.21 | 21.50 | 21.50 | 20.50 | 22.50 | 23.50 | 22.50 | 24.50 | 22.50 |
| Crystallized | n_{d} | | 1.63 | 1.62 | | 1.61 | 1.62 | 1.62 | 1.62 | 1.62 | 1.63 |
| glass | d | 3.18 | 3.21 | 3.11 | 3.09 | 3.05 | 3.11 | 3.12 | 3.14 | 3.16 | 3.15 |
| | Hv | 705 | 679 | 734 | 715 | 719 | 719 | 742 | 733 | 742 | 742 |
| Strengthened | CS | | | 769 | | | | | | | 1150 |
| crystallized | DOLzero | | | 11 | | | | | | | 19 |
| glass | CT | | | 8 | | | | | | | 17 |
| | β | | | 32.1 | | | | | | | 27.8 |
| | Hv | 736 | 783 | 834 | 845 | 847 | 840 | 786 | 840 | 840 | 874 |

TABLE 3

| | | Ex. 21 | Ex. 22 | Ex. 23 | Ex. 24 | Ex. 25 | Ex. 26 | Ex. 27 | Ex. 28 | Ex. 29 | Ex. 30 |
|---|---|---|---|---|---|---|---|---|---|---|---|
| Composition | SiO₂ | 34.72 | 32.72 | 32.72 | 32.72 | 32.72 | 32.72 | 32.72 | 27.72 | 32.72 | 32.72 |
| (mass %) | Li₂O | | | | | | | | | | |
| | Na₂O | 8.70 | 9.20 | 9.20 | 9.70 | 9.70 | 9.20 | 9.20 | 9.20 | 9.20 | 7.50 |
| | K₂O | | | | | | | | | | |
| | Al₂O₃ | 16.00 | 14.00 | 14.00 | 15.00 | 15.00 | 14.00 | 14.00 | 17.50 | 15.00 | 14.00 |
| | P₂O₅ | | | | | | | | 5.00 | | |
| | MgO | 10.00 | 13.00 | 9.00 | 14.00 | 10.00 | 13.00 | 13.00 | 13.00 | 14.50 | 10.00 |
| | CaO | 1.00 | 5.00 | 5.00 | 1.00 | 1.00 | 5.00 | 5.00 | 5.00 | 5.00 | 5.00 |
| | SrO | | | | | | | | | | |
| | BaO | | | | | | | | | | 8.00 |
| | ZnO | 15.00 | 14.00 | 18.00 | 13.00 | 17.00 | 14.00 | 14.00 | 18.00 | 14.00 | 18.20 |
| | ZrO₂ | | | | | | | | 2.00 | | |
| | TiO₂ | 5.00 | 4.50 | 4.50 | 5.00 | 5.00 | 4.50 | 4.50 | 2.50 | 4.50 | 4.50 |
| | Bi₂O₃ | | | | | | 7.50 | | | | |
| | Nb₂O₅ | | | | | | | | | | |
| | Ta₂O₅ | 9.50 | 7.50 | 7.50 | 9.50 | 9.50 | | | | | |
| | La₂O₃ | | | | | | | | | | |
| | Gd₂O₃ | | | | | | | 7.50 | | | |
| | WO₃ | | | | | | | | | 5.00 | |
| | SnO₂ | | | | | | | | | | |
| | Sb₂O₃ | 0.08 | 0.08 | 0.08 | 0.08 | 0.08 | 0.08 | 0.08 | 0.08 | 0.08 | 0.08 |
| | total | 100 | 100 | 100 | 100 | 100 | 100 | 100 | 100 | 100 | 100 |
| Rn₂O (mass %) | | 8.70 | 9.20 | 9.20 | 9.70 | 9.70 | 9.20 | 9.20 | 9.20 | 9.20 | 7.50 |
| MgO + ZnO + Ta₂O₅ (mass %) | | 34.50 | 34.50 | 34.50 | 36.50 | 36.50 | 27.00 | 27.00 | 31.00 | 28.50 | 28.20 |
| ZnO + Ta₂O₅ (mass %) | | 24.50 | 21.50 | 25.50 | 22.50 | 26.50 | 14.00 | 14.00 | 18.00 | 14.00 | 18.20 |
| Crystallized | n_{d} | 1.63 | 1.64 | | | 1.63 | | | | | |
| glass | d | 3.18 | 3.23 | 3.18 | 3.20 | 3.23 | 3.14 | 3.25 | 3.10 | 3.07 | 3.23 |
| | Hv | 742 | 733 | 736 | 740 | 738 | 715 | 733 | 690 | 769 | 724 |
| Strengthened | CS | | | | | | | | | | |
| crystallized | DOLzero | | | | | | | | | | |
| glass | CT | | | | | | | | | | |
| | β | | | | | | | | | | |
| | Hv | 851 | 789 | 803 | 890 | 858 | 880 | 779 | 799 | — | 742 |

TABLE 4

| | | Ex. 31 | Ex. 32 | Ex. 33 | Ex. 34 | Ex. 35 | Com. Ex. 1 |
|---|---|---|---|---|---|---|---|
| Composition | SiO₂ | 30.72 | 34.72 | 31.72 | 32.72 | 32.72 | 53.49 |
| (mass %) | Li₂O | | | | 1.00 | 4.00 | |
| | Na₂O | 7.50 | 7.00 | 7.00 | 7.00 | 7.00 | 10.98 |
| | K₂O | | | | 4.00 | 1.00 | 2.75 |
| | Al₂O₃ | 16.00 | 16.00 | 17.00 | 15.00 | 15.00 | 14.95 |
| | P₂O₅ | | | | | | 0.50 |
| | MgO | 3.00 | 8.00 | 2.00 | 5.00 | 5.00 | 4.19 |
| | CaO | 5.00 | 1.00 | 1.00 | 1.00 | 1.00 | |
| | SrO | | | | | | |
| | BaO | | 8.00 | | | | |
| | ZnO | 33.20 | 20.20 | 36.20 | 19.20 | 17.00 | 10.72 |
| | ZrO₂ | | | | | | 2.30 |
| | TiO₂ | 4.50 | 5.00 | 5.00 | 5.00 | 5.00 | |
| | Bi₂O₃ | | | | | | |
| | Nb₂O₅ | | | | | | |
| | Ta₂O₅ | | | | 10.00 | 12.20 | |
| | La₂O₃ | | | | | | |
| | Gd₂O₃ | | | | | | |
| | WO₃ | | | | | | |
| | SnO₂ | | | | | | 0.12 |
| | Sb₂O₃ | 0.08 | 0.08 | 0.08 | 0.08 | 0.08 | |
| | total | 100 | 100 | 100 | 100 | 100 | 100 |
| Rn₂O (mass %) | | 7.50 | 7.00 | 7.00 | 12.00 | 12.00 | 13.73 |
| MgO + ZnO + Ta₂O₅ (mass %) | | 36.20 | 28.20 | 38.20 | 34.20 | 34.20 | 14.91 |
| ZnO + Ta₂O₅ (mass %) | | 33.20 | 20.20 | 36.20 | 29.20 | 29.20 | 10.72 |
| Crystallized | n_{d} | 1.64 | 1.63 | 1.62 | 1.63 | 1.63 | 1.53 |
| glass | d | 3.32 | 3.24 | 3.32 | 3.24 | 3.24 | 2.67 |
| | Hv | 699 | 742 | 707 | 779 | 779 | 619 |
| Strengthened | CS | | | | | | 1190 |
| crystallized | DOLzero | | | | | | 20 |
| glass | CT | | | | | | 20 |
| | β | | | | | | 28.8 |
| | Hv | 733 | 769 | 819 | 830 | 862 | 730 |

What is claimed is:

1. A crystallized glass, comprising: by mass % in terms of oxide,
20.0% or more and less than 40.0% of a SiO₂ component;
more than 0% and 20.0% or less of a Rn₂O component, where Rn is one or more selected from Li, Na, and K;
7.0% to 25.0% of an Al₂O₃ component;
0% to 25.0% of a MgO component;
0% to 45.0% of a ZnO component; and
0% to 20.0% of a Ta₂O₅ component,
wherein a total amount of the MgO component, the ZnO component, and the Ta₂O₅ component is 10.0% or more.

2. The crystallized glass according to claim 1, comprising: by mass % in terms of oxide,
0% to 15.0% of a TiO₂ component;
0% to 15.0% of a CaO component;
0% to 15.0% of a BaO component; and
0% to 10.0% of a SrO component.

3. The crystallized glass according to claim 1, comprising:
by mass % in terms of oxide,
0% to 10.0% of a ZrO₂ component;
0% to 10.0% of a WO₃ component;
0% to 10.0% of a La₂O₃ component;
0% to 15.0% of a Gd₂O₃ component;
0% to 15.0% of a Bi₂O₃ component;
0% to 10.0% of a P₂O₅ component;
0% to 10.0% of a Nb₂O₅ component; and
0 to 5.0% of a Sb₂O₃ component.

4. The crystallized glass according to claim 1, wherein the total amount of the MgO component, the ZnO component, and the Ta₂O₅ component is 18.0% or more.

5. The crystallized glass according to claim 1, wherein the crystallized glass has a refractive index (n_{d}) of 1.55 or more.

6. The crystallized glass according to claim 1, wherein the crystallized glass has a specific gravity of 3.0 or more.

7. A strengthened crystallized glass comprising: as a base material, the crystallized glass according to claim 1, and further comprising: a compressive stress layer formed in a surface of the strengthened crystallized glass.

8. A strengthened crystallized glass comprising: as a base material, the crystallized glass according to claim 2, and further comprising: a compressive stress layer formed in a surface of the strengthened crystallized glass.

9. A strengthened crystallized glass comprising: as a base material, the crystallized glass according to claim 3, and further comprising: a compressive stress layer formed in a surface of the strengthened crystallized glass.

10. A strengthened crystallized glass comprising: as a base material, the crystallized glass according to claim 4, and further comprising: a compressive stress layer formed in a surface of the strengthened crystallized glass.

11. A strengthened crystallized glass comprising: as a base material, the crystallized glass according to claim 5, and further comprising: a compressive stress layer formed in a surface of the strengthened crystallized glass.

12. A strengthened crystallized glass comprising: as a base material, the crystallized glass according to claim 6, and further comprising: a compressive stress layer formed in a surface of the strengthened crystallized glass.
